(19) United States
(12) Patent Application Publication
(10) Pub. No.: US 2019/0128563 A1
(43) Pub. Date: May 2, 2019

(54) SCHMITTY COMPRESSOR

(71) Applicant: Todd Gerard Schmidt, Shelby Township, MI (US)

(72) Inventor: Todd Gerard Schmidt, Shelby Township, MI (US)

(21) Appl. No.: 16/139,941

(22) Filed: Sep. 24, 2018

Related U.S. Application Data
(63) Continuation-in-part of application No. 15/015,470, filed on Feb. 4, 2016.
(60) Provisional application No. 62/125,889, filed on Feb. 4, 2015.
(60) Provisional application No. 62/561,886, filed on Sep. 22, 2017.

(51) Int. Cl. F24H 1/14; F16K 31/06; F23N 1/00

(52) U.S. Cl. CPC F24H 1/145; F24H 9/2035; F23N 1/005; F16K 31/06

(57) ABSTRACT

A compressor unit providing heat for human use including a combustion housing defining a combustion chamber therein, a magnetic intake valve providing the source of air used in the combustion chamber, and an exhaust valve providing an exit path for exhaust gasses, wherein the exhaust valve can be a pivot exhaust valve, mounted to a combustion pipe wherein an explosive reaction occurs, an igniter operatively attached to the combustion housing, a release valve arranged within the exhale port of the compression housing, a fuel injector operatively attached to the exhale port, a compression housing defining a compression chamber spaced from the combustion chamber and disposed in fluid communication with the combustion process, a half-pipe attached to the compression housing, and a magnetic oscillation unit with an oscillation plate supported on a back and forth moving center piece.

### CROSS-REFERENCE TO RELATED APPLICATIONS

The present application is a continuation-in-part of U.S. patent application Ser. No. 15/015,470, filed on Feb. 4, 2016, which claims priority to and all the benefits of U.S. Provisional Patent Application No. 62/125,889, filed on Feb. 4, 2015, and claims priority to and all the benefits of U.S. Provisional Patent Application No. 62/561,886, filed on Sep. 22, 2017 all of which are herein expressly incorporated by reference in its entirety.

### BACKGROUND OF THE INVENTION

### 1. Field of the Invention

The present invention generally relates to a compressor or compressor unit.

### 2. Description of the Related Art

It is well known to provide a compressor. However, there remains a need in the art to provide a new compressor unit for heating and to sustain heat energy.

### SUMMARY OF THE INVENTION

Accordingly, the present invention provides a magnetic unit for heating and to sustain heat energy including a combustion housing defining a combustion chamber therein, a magnetic intake valve providing a source of air for the combustion chamber, and an exhaust valve providing an exit path for exhaust gasses. The magnetic unit also includes an igniter operatively attached to the combustion housing and disposed in communication with the combustion chamber to house an explosive reaction. The magnetic unit includes a release valve arranged adjacent to an exhale port of the combustion housing and configured to meter out combustion from the combustion chamber, and a fuel injector operatively attached to the combustion housing via a pipe segment and configured to direct fuel into the combustion chamber for use in combustion. The magnetic unit further includes a magnetic oscillation unit with an oscillation plate supported for reciprocal movement in a compression chamber between first and second positions. Movement of the oscillation plate between the first and second positions compresses air directed toward the combustion chamber across the exhale port and a half-pipe adjacent to the compression housing with a magnetic center piece disposed within the half-pipe.

Another advantage of the present invention will be readily appreciated as a motor unit. It becomes better understood by reference to the Schmitty Compressor for its components. And, with limited use of metal, it sustains the production of heat.

### BRIEF DESCRIPTION OF THE DRAWINGS

FIG. 1 is a perspective view of a pipe segment illustrated with an exhale valve, an exhale valve spring, and a magnetic valve seat according to one embodiment of the present invention.

FIG. 2 is a sectional view of a compressor unit according to one embodiment with its shift process located on its centerpiece.

FIG. 3 is a sectional view of the compressor unit of FIG. 2 bias to the left position.

FIG. 4 is a partial sectional view of a magnetic inhale system showing a vented inhale port that contains an inhale valve along with a magnet lifting process.

FIG. 5 is a diagrammatic view of the optical edges of the many inner working arcs of a pivot exhaust valve.

FIG. 6 is a perspective view of a system designed to transfer rotational energy from a fan and into a series of further rotations to spin a shaft and a pulley.

FIG. 7 is a front view of the system of FIG. 6.

FIG. 8 is a top view of the rotational process of FIG. 6, shown with its mirror replicates alongside of it and a stretch wrench at different and opposite sides of the pulling process.

FIG. 9 is a perspective view of an alternative exhaust port and release valve.

FIG. 10 is an enlarged view of the pieces of FIG. 9.

FIG. 11 is an exploded view of the pieces of FIG. 9.

### DETAILED DESCRIPTION OF THE PREFERRED EMBODIMENT(S)

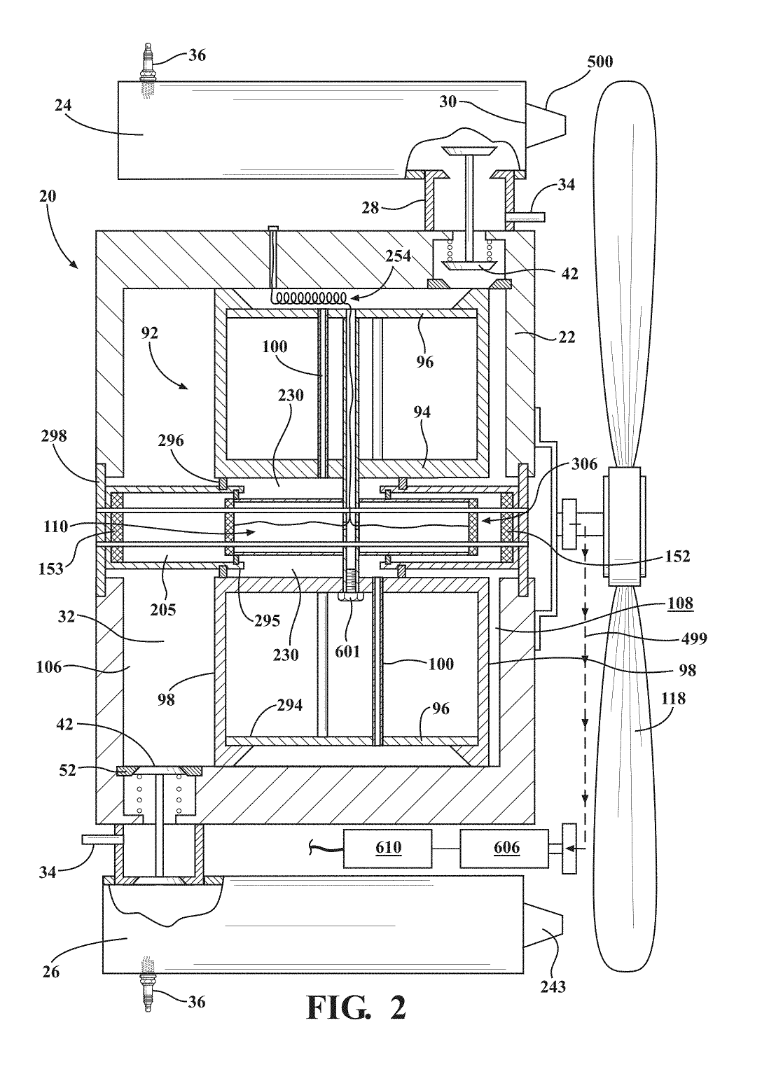

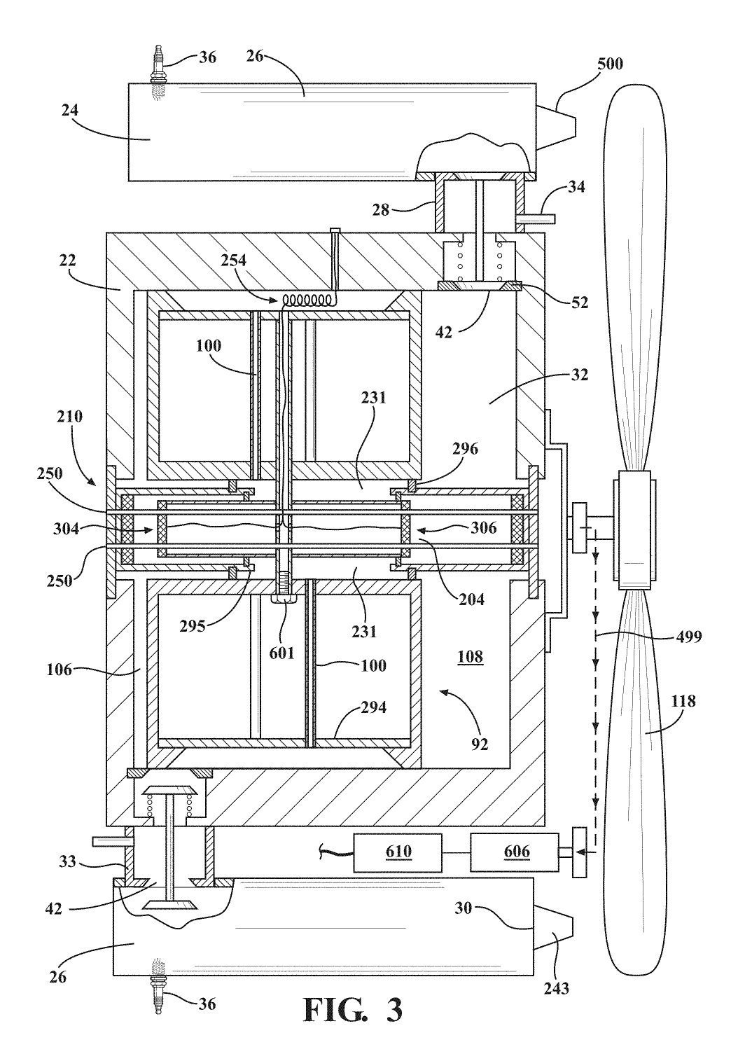

With reference to the Figures, wherein like numerals indicate like parts throughout the several views of a compressor unit 20 for heating and sanitizing water for human use is provided. The compressor unit 20 is shown generally in FIGS. 2 and 3.

Referring to FIGS. 2 and 3, the compressor unit 20 includes a compression housing 22 and a combustion housing 24. The combustion housing 24 is disposed on the compressor unit 20 and is spaced from the compression housing 22. The combustion housing 24 defines a combustion chamber 26 therein and further defines an exhale port 28 and an exhaust port 30. The exhale port 28 provides a passage for air into the combustion chamber 26, and the exhaust port 30 provides an exit path for exhaust gasses. It is to be appreciated that the combustion housing 24 may define more than one exhaust valve in certain embodiments.

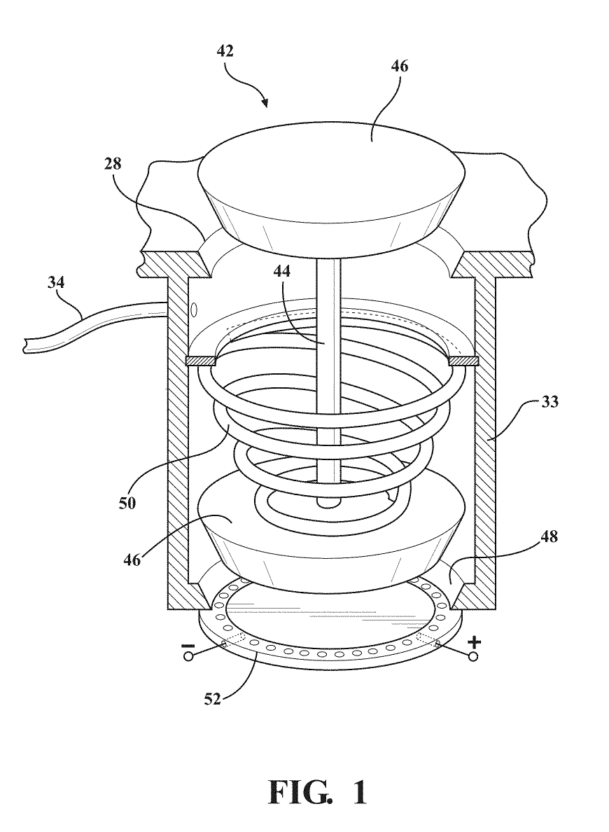

The compression housing 22 is a hollow cylinder that defines a compression chamber 32 therein. The compression housing 22 is coupled to the combustion housing 24 such that the compression chamber 32 is in fluid communication with the combustion chamber 26 at each exhale port 28 by a pipe segment 33 (FIG. 1). The compression chamber 32 provides a source of air to the combustion chamber 26.

In one embodiment, the combustion housing 24 is further defined as a plurality of combustion housings 24. The combustion housings 24 are radially arranged around the cylindrical compression housing 22. Each of the combustion housings 24 define a combustion chamber 26 therein. Each combustion chamber 26 is in fluid communication with the compression chamber 32. The combustion chambers 26 may be interconnected or discrete.

Shown in FIGS. 2 and 3, the compressor unit 20 includes an oscillation plate 92 disposed in the compression housing 22. The oscillation plate 92 is generally a cylindrical section. The oscillation plate 92 may be assembled from an inner hoop 94 segment, an outer hoop 96 segment, and two circular side panels 98. The inner and outer hoop 94, 96 segments interlock with the two side panels 98 to assemble the oscillation plate 92. A hollow reinforcement rod 100, shown in FIGS. 2 and 3, couples the two hoop segments 94, 96 and strengthens the oscillation plate 92. Another embodiment is shown in FIGS. 2 and 3 with one oscillation plate 92.

Referring back to FIG. 3, oscillation plate 92 separates the compression chamber 32 into a first portion 106 and a second portion 108. Movement of oscillation plate 92 into the first position compresses air in the first portion 106 of the compression chamber 32. Movement of the oscillation plate 92 between the first and second positions compresses air in the respective portion 106, 108 of the compression chamber 32 and moves the air across the exhale port 28 into the combustion chamber 26.

A center piece 110 supports the oscillation plate 92 for reciprocal movement in the compression housing 22. The oscillation plate 92 is disposed around the center piece 110. The oscillation plate 92 is movable along with and relative to the center piece 110 between a first position and a second position which causes the oscillation plate 92 to move respectively between the first position and the second position. Because of a fastener bolt 601, the center piece 110 supports the oscillation plate 92.

The compressor unit 20 includes a fuel injector 34 operatively attached to each of the pipe segments 33 of the combustion housings 24, as shown in FIG. 1. The fuel injector 34 is configured to direct fuel into the pipe segment 33 for use in combustion. A pressurized fuel source (not shown) supplies fuel to the fuel injector 34.

Referring again to FIGS. 2 and 3, the compressor unit 20 includes an ignitor 36 operatively attached to the combustion housing 24 and disposed in communication with the combustion chamber 26. The ignitor 36 is used to initiate an explosive reaction wherein the fuel in the combustion chamber 26 is ignited and rapidly burns. The ignitor 36 may initiate the explosive reaction by way of an electrical arc or spark or by providing a heat source. The ignitor 36 may take several forms such as a spark plug, a glow plug, and other ignitors commonly known in the art.

As illustrated in FIG. 1, the exhale valve assembly also includes an exhale valve spring 50 disposed about each of the exhale valves 42 to bias the exhale valve 42 into a closed position. The exhale valve spring 50 may be arranged around the elongated stem 44 between the second head portion 46 of the exhale valve 42 and the compression housing 22. The exhale valve spring 50 may be a helically wound frustoconical type spring; however, it is to be appreciated that the exhale valve spring 50 may take other forms, such as cylindrical or beehive, as is commonly known in the art.

The valve seat 48 is disposed in the compression housing 22 adjacent to the exhale valve 42 and spaced from the exhale port 28. The magnetic valve seat 48 includes a magnet 52 to bias the exhale valve 42 in a closed position. The magnet 52 creates an attraction force between the magnetic valve seat 48 and the exhale valve 42. The attraction force further biases the exhale valve 42 toward the closed position. The magnet 52 holds the exhale valve 42 in the closed position until pressure in the compression chamber 32 is large enough to turn off the attraction force and allow the exhale valve 42 to open. The magnet 52 reduces a valve float effect by requiring an elevated pressure within the compression housing 22 to turn off the attraction force from the magnet 52. The pressure that turns off the attraction force of the magnet 52 is greater than the initial pressure required to open the exhale valve 42 by the exhale valve spring 50. By reducing the valve float effect, greater pressure can be generated in the compression housing 22 before being released into the combustion chamber 26. In one embodiment, the magnet 52 is an electro-magnet, but permanent magnets are additionally contemplated.

The movement of the oscillation plate 92 compresses the air in the first portion 106 of the compression chamber 32 until the oscillation plate 92 reaches the first position. When peak pressure is reached in the first portion 106 of the compression chamber 32, the exhale valves 42 in communication with the first portion 106 of the compression chamber 32 open and release air into the combustion chamber 26. The exhale valves 42 close when the pressure between the first portion 106 of the compression chamber 32 and the combustion chamber 26 equalizes. The fuel injector 34 injects fuel into the pipe segment 33 before it is pressure sprayed into the combustion chamber 26 under pressure.

With the exhale valves 42 closed, the magnet 252 opens the intake valves 270 in the first portion 106 of the compression chamber 32 and closes the intake valves 270 in the second portion 108 of the compression chamber 32.

The air and fuel in the combustion chamber 26 is ignited by the ignitor 36, creating an increase in heat and pressure in the combustion chamber 26. The heat produced by igniting the fuel and air is transferred into the heat fan 118. The pressure produced by igniting the fuel and air increases until it reaches a predetermined level. At the predetermined level the pressure forces the exhaust pivot valve 243 open. Exhaust flows out of the combustion chamber 26 through the exhaust pivot valve 243 and into the heat fan 118 inducing rotation. When the pressure in the combustion chamber 26 falls below the predetermined level, the exhaust pivot valve 243 closes.

The rotation of the heat fan 118 is transferred by the trans 499. The movement of the oscillation plate 92 toward the second position compresses the air in the second portion 108 of the compression chamber 32 until the oscillation plate 92 reaches the second position. When peak pressure is reached in the second portion 108 of the compression chamber 32, the exhale valves 42 in communication with the second portion 108 of the compression chamber 32 open and release air and fuel into the combustion chamber 26. The exhale valves 42 close when the pressure between the second portion 108 of the compression chamber 32 and the combustion chamber 26 equalizes. The fuel injector 34 injects fuel into the pipe segment 33 before the fuel flows into the combustion chamber 26.

The fuel and air in the combustion chamber 26 is ignited and drives the heat fan 118. Exhaust from combustion flows out of the combustion chamber 26 through the exhaust valves 243, 500 in a manner consistent with the above description. The entire operation cycle of the compressor unit 20 is repeated as described, until deactivated.

In the embodiment, as illustrated in FIGS. 2 and 3 and according to the present invention, the compressor unit 20 shows how to effectively accelerate the compressor process by a magnetic pulse for the Schmitty Compressor, which is designed to offset the set back of the electric current delay. In this embodiment, the compressor unit 20 now includes electron magnets 152, 153 to shift the compressor. The magnets 152, 153 are disposed adjacent to each other on opposite sides of 306 and 304 of the center piece 110. The electron magnet 152 can alternate attraction with the other electron magnet 306 on the opposite side of an attraction chamber 204. The electron magnet 153 can alternate attraction with the other electron magnet 304 on the opposite side of an attraction chamber 205. It should be appreciated that the attraction chamber 204, 205 are defined as being between the center piece 110 magnetic ends, and the half pipe magnetic faces.

The magnetic intake valve 270 has an elongate stem portion 272 and two head portions 274 arranged at each end of the stem portion 272. The head portions 274 may be substantially circular in shape.

The magnetic intake valves 270 operate just as the oscillation process operates. Only half of the magnetic intake valves 270 for each of the air intake process, proceeds with the process as the other half of the magnetic intake valves 270 wait. It should be appreciated that this purpose is to alternate a functional occurrence in order to speed up the reaction time of the magnetic system 210. This method will offset the set back of magnetic and electric current delay.

The intake chamber 286 is arranged radially around the compressor unit 20 and contains two intake valves 270 at each end. The intake housing 287 contains all the parts for the intake process.

The electric currents of a generator 606, for all magnets, are generated by the circular motion of the heat fan 118. The energy of the rotating fan 118 is transferred to a generator 606 by a pulley system known as the trans 499, 499. All current distribution is via a computer box 610.

Another embodiment of the magnetic system 210 includes an additional piece to keep the compressor unit 20 from spinning the oscillation plate 92 when operating. A plurality of alignment spokes 250 will go from side to side through the center piece 110. As illustrated in FIGS. 2 and 3, the magnetic devices or magnets 152, 153, 306, 304 have holes around the outer edge of their shape. These holes contain the alignment spokes 250. It should be appreciated that the purpose for the additional piece is to prevent an electric supply wire 254 for the inner magnets from being extended too far. Another method to prevent spin is to slightly elongate the circle compressor unit 20.

Between two portions of the compression chambers 106 and 108 is an oscillation plate 92. In one embodiment, the oscillation plate 92 is circular and contains offset hollow reinforcement rods 100 that double as an oil flow transfer line. The oscillation plate 92 oscillates side to side and compresses the indrawn air. Through the connection of the oscillation plate 92 to the center piece 110, the operation cycle of the compressor unit 20 is provided.

The center piece 110 oscillates by the attraction of the electron magnets 152, 153 and the sides 304, 306. The electron magnets 152, 153 are at the inside center of each side of the compressor 20. The electron magnets 152, 153 are attached to a half-pipe 298, which has a wider circumference than the center piece 110. The base of the oscillation plate 92 moves over rings 296 on the outside of the half-pipe 298. The outside of the center piece 110 moves under rings 295 on the inside of the half-pipe 298. The rings 296 and 295 also seal the oil flow reservoir 230 and 231 on the outside of the center piece 110. It should be appreciated that the fluids, such as oils are compressed by the shifting of the center piece 110 into and through the rods 100 and then into the other reservoir.

The center piece 110 includes a center notch (not shown) that is the mount for the oscillation plate 92. On the surface of each side of the notch is a place for a ring of brake pad material (not shown). A structural plate 294 is attached to the upper portion of walls 98 of the oscillation plate 92 to reinforce structural soundness. It should be appreciated that the compression housing 22 is also the surface to the remaining parts of the above compressor unit 20.

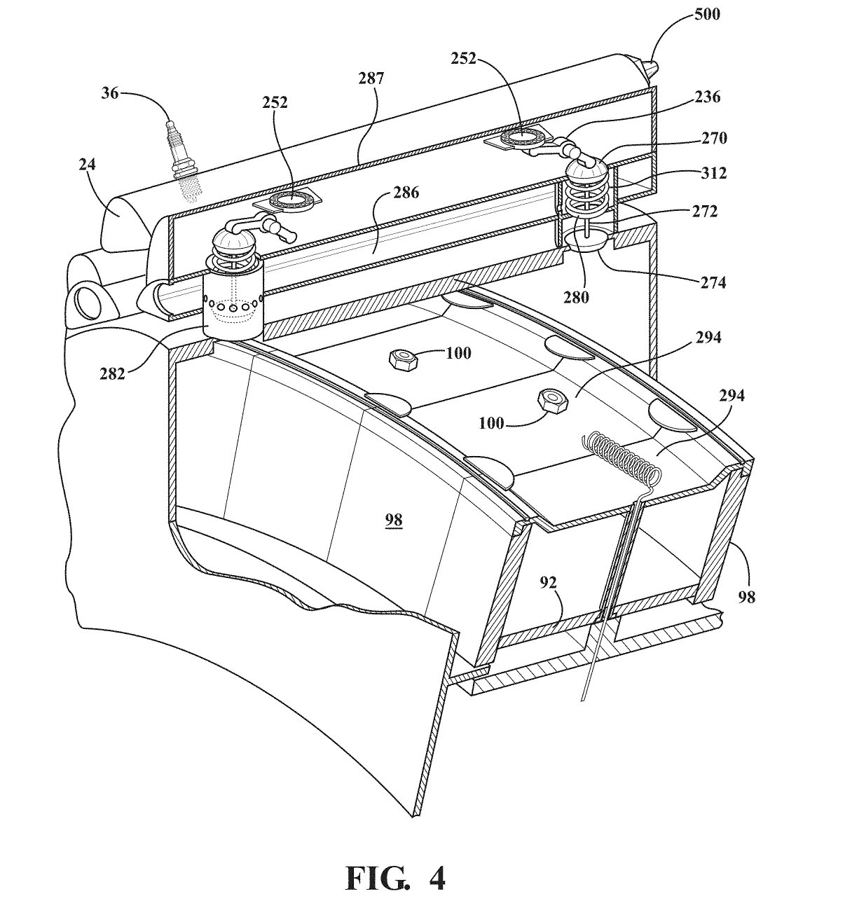

In another embodiment illustrated in FIG. 4, the intake valve of the compressor unit 20 can be a magnetic intake valve 270. The magnetic intake valve 270 is surrounded by a valve spring 280. The valve spring 280 is positioned on a ledge 312 that is attached to an inside wall of a vented sleeve 282 of the magnetic intake valve 270. The response of the valve spring 280 after its compression is to open the intake valve 270 upward. The downward motion of the magnetic intake valve 270 is to seal the bottom which is possible by the electron magnet 252. By the upward attraction by one end of an intake rocker arm 236 with the electron magnet 252, the opposite side of the rocker arm 236 moves down transferring a down motion to the magnetic intake valve 270 and sealing the magnetic intake valve 270 at the bottom. The electron magnet 252 will remain on for the magnetic intake valves 270 during the increase of air pressure within the two portions 106, 108 of the compression chamber 32.

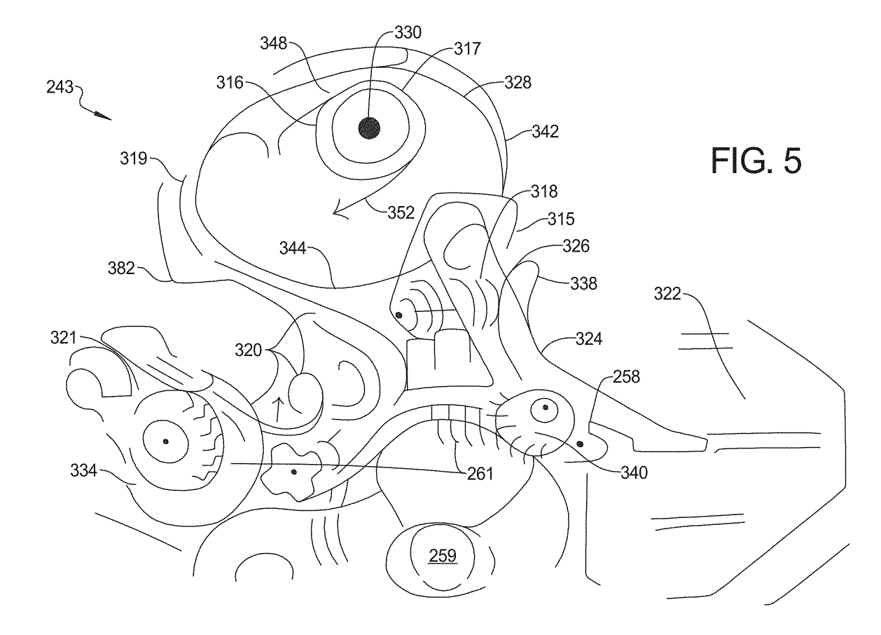

In another embodiment, as illustrated in FIG. 5, the compressor unit 20 includes an alternative exhaust valve 243 to be described. In this embodiment, a pivot exhaust valve 243 is attached to the end of a combustion chamber 24 of the compressor unit 20. The exhaust valve 243 is designed to be opened by the pressure of combustion and closed by the tension of three springs 316, 318, and 320. A pivot 7 exhaust valve bottom 322 is of multiple panels to vent a greater combustion flow. The exhaust valve 243 connects the combustion with the rotational heat fan.

In another embodiment, an additional spring can mirror the placement of a hand grip spring 316 on the opposite side of a pivot eye 330. Thus, providing more tension.

Referring to FIG. 5, in another embodiment, according to the present invention, the exhaust valve 243 and is also known as the pivot 7 exhaust valve 243. The pivot 7 exhaust valve 243 releases pressure and then re-seals. The compressor unit 20 includes a plurality of valve panels 322 at the base of the pivot 7 exhaust valve 243. Each valve panel 322 is in the start position when down and surrounded by a seal (not shown) along their edge. A moment of extreme pressure is caused below each valve panel 322 that move the panels away from the seal and upward. The energy of the motion by the valve panels 322 is transferred into the three springs 316, 318, and 320 via a network of seven members 322, 324, 326, 328, 330, 382, and 334 to be described as the inner working arcs. The transfer of energy from the motion of the valve panel 322 is transferred to the rest of the inner working arcs by a lever cog 324. The pivot point 258 of the lever cog 324 is behind the base of an inner passage wall 310 of the valve. It should be appreciated that the first motion of the lever cog 324 is hard thus making the return to the start position quick.

There are three points of contact with the lever cog 324 that transfers the effect of the motion created. At the inside center of the lever cog 324, there is a string lobe 338. As the string lobe 338 goes down and forward, by map of its arc, a straw pipe 326 goes forward and up. On both sides of the inside base of the lever cog 324 are universal gears 340 intended to provide a strong connection with bowling pin gears 261. That makes possible the motion of a bowling pin lobe 334 and other parts. As the universal gears 340 rotate down, the back of the bowling pin lobe 334 is moved down and behind its own pivot point 259. It should be appreciated that the raising of the head of the bowling pin lobe 334, to a point similar to shown; provides the tension for outside strands 321 of a collar spring 320.

An anchor bay collar 382 is wrapped around the base of the fish head lobe 328. An inner strand 319 of a collar wrap spring 320 is disposed within the anchor bay collar 382. The anchor bay collar 332 actually counters the action of the bowling pin lobe 334 on the collar wrap spring 320. It should be appreciated that this cooperation is the completion of the spring's tension. The center coil of the collar wrap spring 320 is stationary.

The pivot eye 330 is the center point of all the members of the inner working arc's, moving them up while also moving others down. The combination of the moving actions compresses the three springs 316, 318, and 320. The return of the springs 316, 318, and 320 to the start position is the result of the inner working arcs of the exhaust valve 243. When all of the members 322, 324, 326, 328, 330, 382, and 334 return to the start positions, the process is completed.

The fish head lobe 328 surrounds the pivot eye 330 and has a nose 342, a belly arc, and a jaw bone arc 344 on each side. The nose 342 is pushed upward by the straw pipe 326. Consequently, behind the pivot eye 330, the back of the fish head lobe 328 motions down on the anchor bay collar 382. A mouse trap spring 318 is located beneath the fish head lobe 328. The tension of the back end 314 of the mouse trap spring 318 is created by the back and bottom of the fish head lobe 328 going down. As the nose 342 of the fish head lobe 328 goes up, the jaw bone arc 344 comes forward and presses down the forward end 315 of the mouse trap spring 318. Consequently, each side of the mouse trap spring 318 is spread apart from each other and then returns. It should be appreciated that the tension achieved by spreading apart the coils effects spring 318 front and back. The center coil of the mouse trap spring 318 is stationary.

A hand grip spring 316 has its coil 317 in the center of the fish head lobe 328 and surrounding the cavity of the pivot eye 330. A top coil strand 348 extends from the top end of the spring coil 317 and goes along the top of the fish head lobe 328 where the top coil strand 348 is thereto connected. The coils bottom strand 352 is extended from the bottom end of the hand grip spring 316. While on a downward angle, from the bottom end of the coil 317, the strand 252 extends out of the bottom and back of the fish head lobe 328. The bottom coil strand 352 is connected with an outer containment wall (not shown) of the pivot 7 exhaust valve 243. The motion of the fish head lobe 328 compresses the top coil strand 316 into the direction of the mounted bottom coil strand 352. It should be appreciated that the tension is achieved by the closing motion of the hand grip spring 317. The center coil of the hand grip spring 317 is stationary.

It should be appreciated that the new and improved pivot 7 exhaust valve 243 is to increase the performance of the Schmitty Compressor and or other compressor units. The magnetic system 210 is able to shift the oscillation plate 92 quickly. The pivot 7 exhaust valve 243 and the use of the three springs, 317, 318, and 320, is to open and close the seal of the pivot exhaust valve 243 at the quicker pace of the magnetic system 210. Although not shown, the pivot exhaust valve 243 can contain a total of five springs. The mirror image of the valve 243, as illustrated in FIG. 5, will allow the process of the spring 316 and spring 320 to be duplicated.

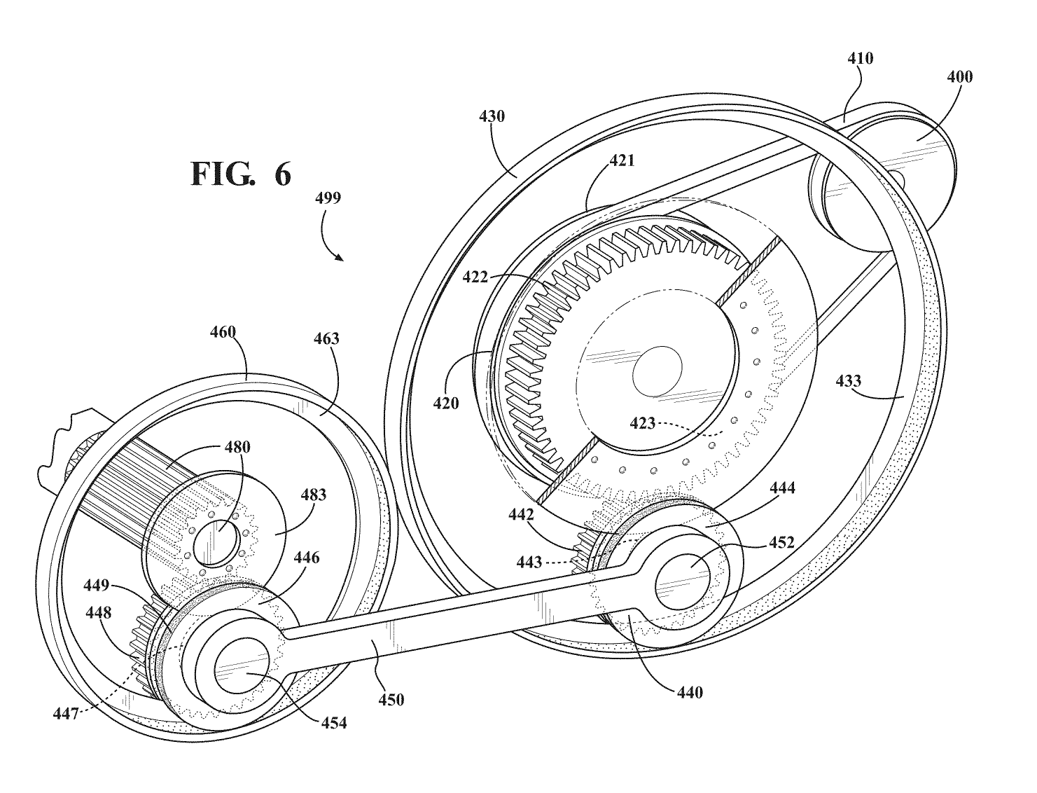

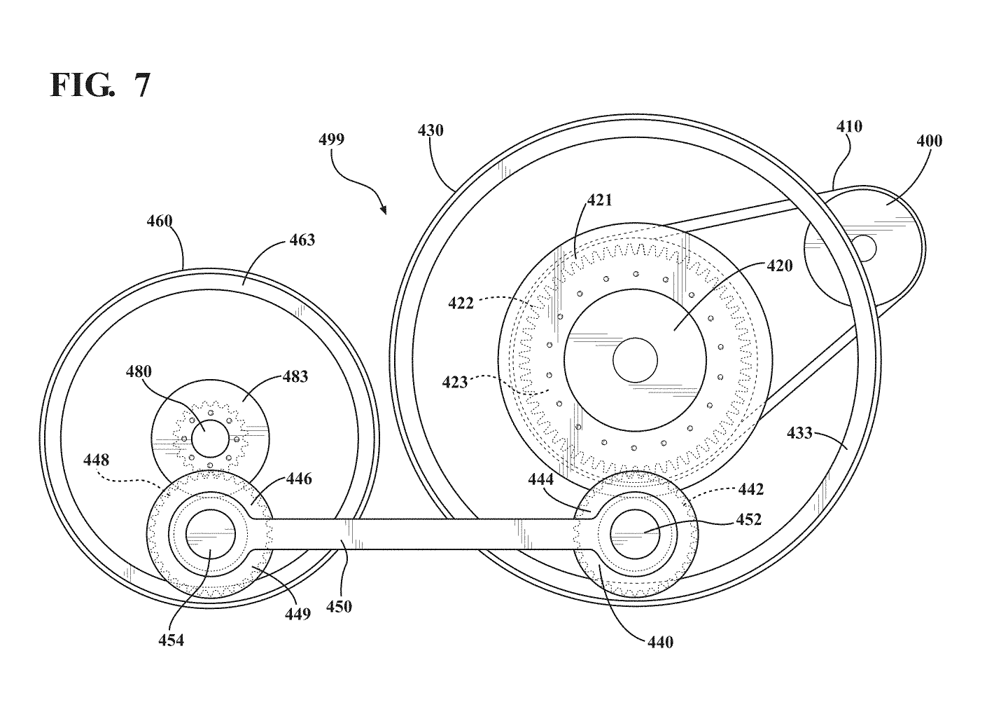

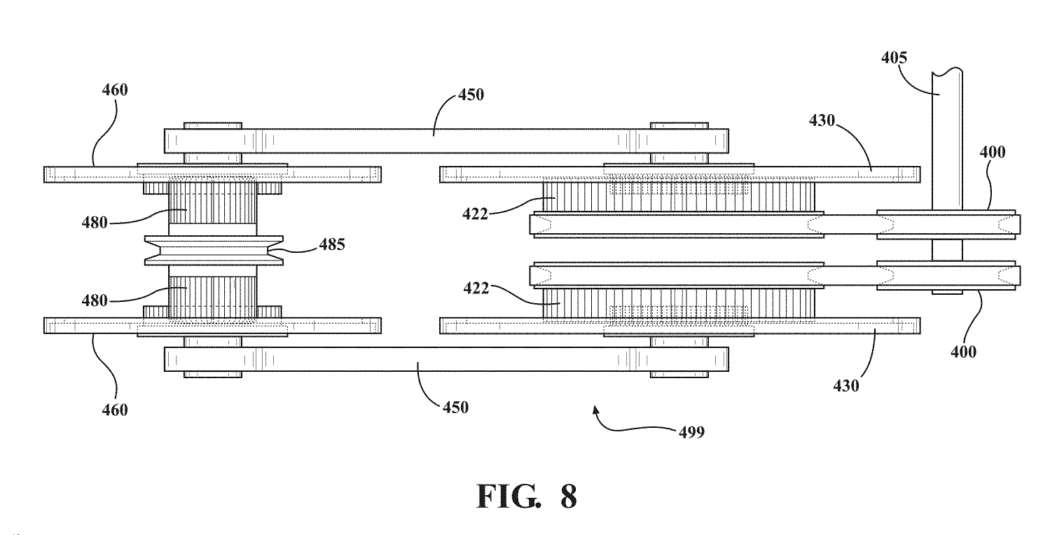

In another embodiment, as illustrated in FIGS. 6-8 and according to the present invention, where from a heat fan 118 (FIGS. 2 and 3) that collects energy from expanding gas and heat and then passes it to an exhaust pipe, where such a heat fan 118 rotation is responsible for the energy that turns this new and innovative transfer process into producing electricity from a generator. The electricity of such generator allows the spark and magnetic systems to cause the illustrated processes to complete the functional recipe that rotate the heat fan 118 with expanding gas.

To start the transfer of energy through the trans 499 provided by the heat fan transfer shaft 405, a pulley 400 is attached to it. The energy from the small pulley 400 is transferred by a belt 410 to a large pulley 420. The two sides 421, 422 of the large pulley 420 have different surfaces that correlate with the needs of the belt 410 and a gear 442. This part of the system is located in the center of a large guide ring 430.

Along the outer edge of 422 is an extension of pulley 420. The inside guide edge 423 enters coin 440 along its center gap 443. Along the inner edge of 430 is an inward extension 433. This outside guide edge 433 enters coin 440 along its center gap 443. The center gap 443 of coin 440 separates the different surfaces on each of its sides.

In between the edges of the pulley 420 and ring 430 is a double sided coin 440. The coin 440 is similar to coin 446, and both coins 440, 446 have different surfaces on their opposite sides. Coin side 442 has a gear, and coin side 444 has an abrasive surface. The coin 440 rolls in between and is held in place by the guide edges 423, 433 of the pulley 420 and ring 430.

The rotation of the coin 440 is connected to a two sided stretch wrench 450 at the sending end 452 of the two sided stretch wrench 450. The energy from the rotation of the heat fan 118 is slowed once more by the stretch wrench 450 as it transfers the spin process into a smaller circumference of a small guide ring 460. Within the small guide ring 460, is the guided coin 446. This coin 446 is also double sided with a gear side 448 and an abrasive side 449. The two ends of the stretch wrench 450 houses the double-sided coins 440 and 446.

Along the outer edge of 480 is an extension of the drive shaft 480. The inside guide edge 483 enters coin 446 along its center gap 447. Along the inner edge of 460 is an inward extension 463. This outside guide edge 463 enters coin 446 along its center gap 447. The center gap 447 of coin 446 separates the different surfaces on each of its sides.

The reaction from the spinning coin 446 in the small guide ring 460 is transferred to a final rotation. The drive shaft 480 is capable of rotation by its connected purpose to all parts of 446. The wrench end 454 is connected to, and able to pull gear side 448 along the edge of drive shaft 480. This process transfers rotation to the drive shaft 480.

In the center of the small guide ring 460 is the drive shaft 480. This drive shaft 480 is driven by the orbit of the double-sided coin 446. Each guide ring 430 and 460 has an abrasive surface that contacts the coins 440 and 446. Each gear side of the coins 440 and 446 makes contact with the drive function in the center of the guide rings 430 and 460.

In addition, as for the rotation of shaft 480 and its pulley wheel 485, by the pull of a stretch wrench 450; the completion of a full circle pulling services is conducted by a mirror arrangement of duplicated systems moving their own stretch wrench. The two mirror systems of rotational transfer are set to provide the pull of a stretch wrench 450 at opposite occurrences. And so, both ends of shaft 480 are able to receive their rotational energy at alternating moments.

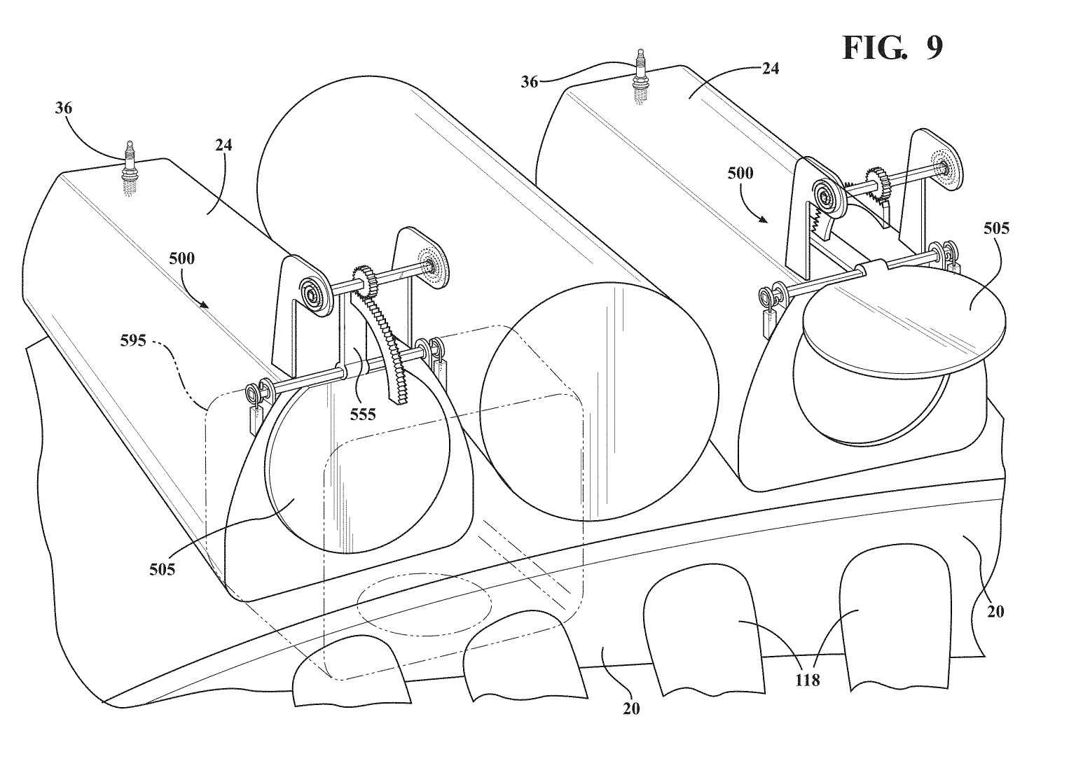

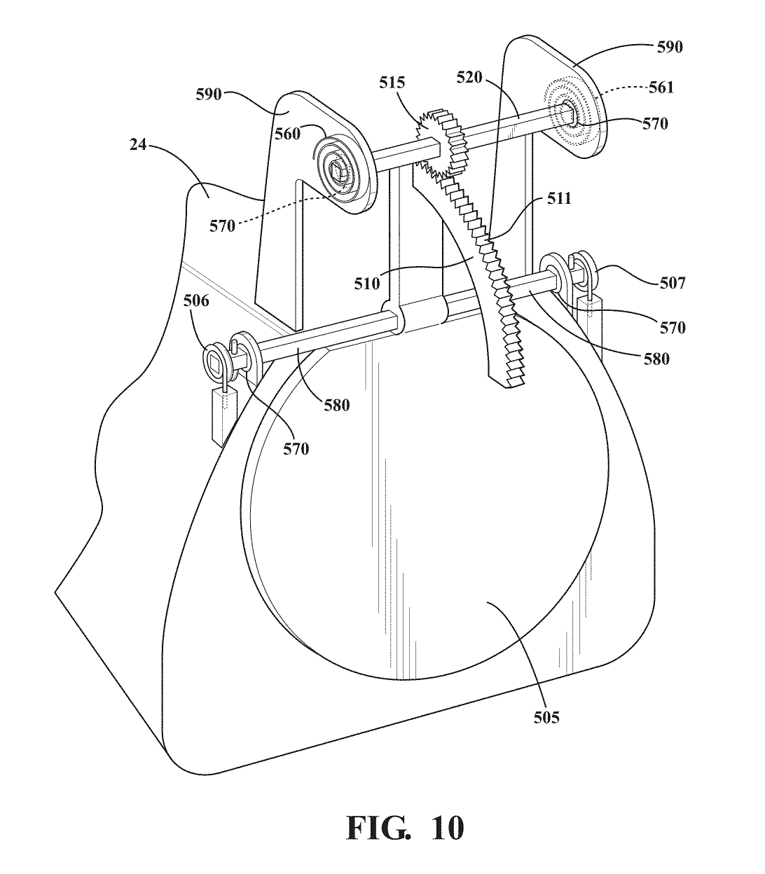

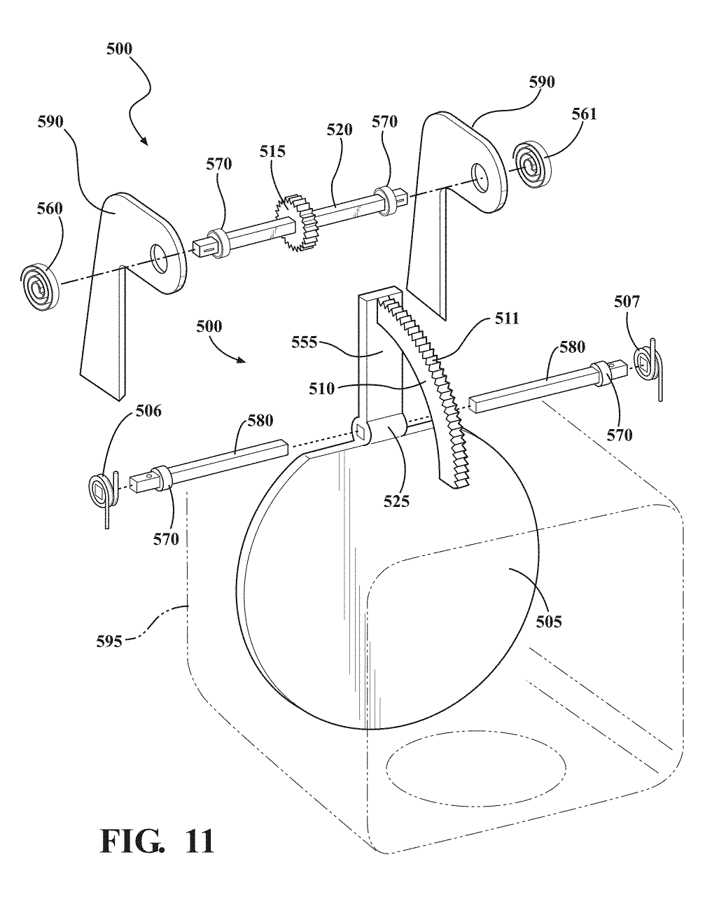

In another embodiment, as illustrated in FIGS. 9-11, the compressor unit 20 includes an alternative exhaust valve 500, which will be described. In this embodiment, an exhaust valve 500 is attached to the end of the combustion chamber 24 of the compressor unit 20. The exhaust valve 500 is designed to be opened by the pressure of combustion and closed by the tension of multiple springs 507, 506, 560, 561. The exhaust valve bottom is of one panel 505, to vent a combustion flow ignited behind it. The valve system 500 connects the combustion with the rotational heat fan.

The springs of 560, 561 are positioned with the sprocket 515 and within the valve containment walls 590. To seal the exhaust valve panel 505 the valve utilizes a new tension system container. The tension of exhaust valve springs 560, 561 is influenced, by the sprocket 515 as they rotate in the motion of the sectional gear 510 from bottom to top.

Referring to FIGS. 9-11, as an embodiment of the Teamster 500, according to the present invention, the exhaust valve 500 is also known as the Teamster 500. The exhaust valve releases pressure and then re-seals. The unit includes a valve panel 505 at the base of the combustion pipe 24. The valve panel 505 is in the start position when down and surrounded by a seal (not shown) along the edge of the inner passage wall 595. A moment of extreme pressure is caused below the valve panel 505 that moves the panel away from the seal and upward. The energy of the motion by the valve panel 505 is transferred into multiple springs 507, 506, 560, 561 via a network of sprockets 515 and a horizontal axis. Also, rods 520, 580 are used to mount the sprockets and secure them to the valve containment wall 590. The transfer of energy from the motion of the valve panel 505 is transferred to the inner working arcs of 590 by a sectional gear 510. The pivot point 525 of the Teamster 500 is behind the base of the inner passage walls 595 of the valve and below the containment wall 590 of the inner working arc's. It should be appreciated that the first motion of the panel 505 is hard, thus making the return to the start position quick.

There are two points of contact with the sectional gear 510 that transfers the effect of the motion created. At the inside center of the sectional gear 510, there are rows of gear teeth 511. As the sectional gear 510 goes up and backward, by map of its arc, a rotation occurs with the sprockets 515 caused by their positioning with in the sectional gear. This in turn increases the tension on multiple springs 507, 506, mounted with the sprockets.

As shown in FIGS. 9-11, the x-y axis of the vertical surface 555 is the frame work from which the Teamster 500 piecemeal is assembled to. The vertical surface 555 of the x-y axis is the mount for the sectional gear 510 and the valve panel 505. The horizontal axis is the mount for the outside torsion springs 506, 507. To the inside of the torsion spring mounts is a risen rod surface 570 for a bearing system. The horizontal axis has a square shaped center to lock into the vertical surface 555 at its pivot point 525. The upward motion of the valve panel 505 twists the horizontal rod 580 and tightens the outside torsion springs 506, 507.

It should be appreciated that the new and improved exhaust valve 500 is to increase the performance of the Schmitty Compressor and or other compressor units. The magnetic system 210 is able to shift the oscillation plate 92 quickly. The exhaust valve 500 and the use of multiple springs, is to open and close the seal of the valve at the quicker pace of the magnetic system 210.

The present invention has been described in an illustrative manner. It is to be understood that the terminology which has been used is intended to be in the nature of words of description rather than of limitation. Many modifications and variations of the present invention are possible in light of the above teachings. The present invention may be practiced other than as specifically described. This practice is forth coming and could benefit a first to file inventor.

What is claimed is:

1. A magnetic unit for heating, and to sustain heat energy comprising:
a combustion housing defining a combustion chamber therein, a magnetic intake valve providing a source of air for said combustion chamber, and an exhaust valve providing an exit path for exhaust gasses;
An igniter operatively attached to say combustion housing and disposed in communication with said combustion chamber to house an explosive reaction;
A release valve arranged adjacent to an exhale port of said combustion housing and configured to meter out combustion from said combustion chamber;
a fuel injector operatively attached to said combustion housing via a pipe segment and configured to direct fuel into said combustion chamber for use in combustion;
a magnetic oscillation unit with an oscillation plate supported for reciprocal movement in said compression chamber between first and second positions wherein movement of said oscillation plate between said first and second positions compresses air directed toward said combustion chamber across the exhale port; and
a half-pipe adjacent to said compression housing with a magnetic center piece disposed within said half-pipe.

2. A magnetic unit as set forth in claim 1 wherein said half-pipe is in fluid communication with said compression housing and having a circumference larger than that of a center piece.

3. A magnetic unit as set forth in claim 1 including a center piece disposed inside of said half-pipe.

4. A magnetic unit as set forth in claim 1 wherein said half-pipe has a plurality of electron magnets disposed on either side.

5. A magnetic unit as set forth in claim 3 wherein said center piece has said electron magnets on both faces and on opposite sides of said center piece.

6. A magnetic unit as set forth in claim 2 wherein said center piece comprises an attraction chamber wherein its face and an opposite side of said center piece define two sides of said attraction chamber.

7. A magnetic unit as set forth in claim 1 further including a pulley system coupled to a heat fan and a generator by a belt and gear process, wherein said belt and gears are configured for rotating said pulley system.

8. A magnetic unit as set forth in claim 7 wherein a mechanical transfer of rotational energy from the heat fan thru a drive system and to an electric generator.

9. A magnetic unit as set forth in claim 4 wherein said oscillation plate is circular and oscillates by said electron magnets to compress indrawn air, and wherein said oscillation plate is kept aligned by a plurality of alignment spokes preventing the spinning of said oscillation plate.

10. A magnetic unit as set forth in claim 9 wherein said alignment spokes prevent an electric supply wire from being extended too far.

11. A magnetic unit as set forth in claim 4 wherein said half-pipe has a plurality of rings on an inside and an outside of said half-pipe.

12. A magnetic unit as set forth in claim 11 wherein said rings on the outside of said half-pipe are between said oscillation plate and a half-pipe wall and wherein said rings on the inside of said half-pipe are between said center piece and said half-pipe wall.

13. A magnetic unit as set forth in claim 12 wherein said rings on the outside of said half-pipe allow said oscillation plate to oscillate.

14. A magnetic unit as set forth in claim 12 wherein said rings on the inside of said half-pipe allow said center piece to oscillate between said elections magnets.

15. A magnetic unit as set forth in claim 11 wherein said rings on the outside and inside of said half-pipe seal an oil flow, said oil flow is circulated through the internal cavities of said compressor to lubricate its oscillation.

16. A magnetic unit as set forth in claim 1 wherein said magnetic intake valve is surrounded by a valve spring, wherein said valve spring is positioned on a ledge that is attached to a vented intake port of said magnetic intake valve.

17. A magnetic unit as set forth in claim 1 wherein said combustion pipe houses the explosive reaction that combines a plurality of properties introduced to each other under pressure.

18. A magnetic unit as set forth in claim 1 wherein said exhaust valve is a pivot 7 exhaust valve comprising a plurality of springs, a bowling pin and fish head lobe, a plurality of interworking arcs, a lever cog, a pipe, and a collar.

19. A magnetic unit as set forth in claim 18 wherein said springs comprises of a hand grip spring, a mouse trap spring, and a common wrap around spring.

20. A magnetic unit as set forth in claim 18 wherein said pivot 7 exhaust valve uses said springs, said valve panel, said lobes, the lever cog, the pipe and the collar to complete a tension of the springs to open said pivot 7 exhaust valve, wherein the release of tension then re-seals said pivot 7 exhaust valve.

21. A magnetic unit as set forth in claim 1 wherein a Teamster 500 exhaust valve uses a single valve panel and multiple springs, connected by a sectional gear and sprockets, to create tension within the system, for a quick return of the single valve panel to the closed position.
